(19) United States
(12) Patent Application Publication
(10) Pub. No.: US 2026/0316655 A1
(43) Pub. Date: Oct. 15, 2026

(54) UNDER STRUCTURE OF VEHICLE BODY

(71) Applicants: Hyundai Motor Company, Seoul (KR); Kia Corporation, Seoul (KR)

(72) Inventors: Hyeongwoon Lee, Hwaseong-si (KR); Jiae Yong, Hwaseong-si (KR); Jinyoung Mo, Hwaseong-si (KR)

(21) Appl. No.: 19/564,981

(22) Filed: Mar. 12, 2026

(30) Foreign Application Priority Data
Apr. 9, 2025 (KR) 10-2025-0045989
Jul. 10, 2025 (KR) 10-2025-0092972

(51) Int. Cl. B60P 1/43; A61G 3/06; A61G 3/08; B60N 2/015; B60N 2/30; B62D 21/03; B62D 25/20

(52) U.S. Cl. CPC B60P 1/433; A61G 3/061; A61G 3/0808; B60N 2/015; B60N 2/3097; B62D 21/03; B62D 25/2018; B62D 25/2027; B62D 25/2036

(57) ABSTRACT

An under structure of a vehicle body may include a rear floor structure, a front transverse member connected to an upper front portion of the rear floor structure along a vehicle width direction, a rear transverse member disposed to be spaced apart from the front transverse member and connected to an upper portion of the rear floor structure along the vehicle width direction, and a rear flattening panel on and connected to the front transverse member and the rear transverse member.

### CROSS-REFERENCE TO RELATED APPLICATIONS

This application claims priority to and the benefit of Korean Patent Application No. 10-2025-0045989 filed with the Korean Intellectual Property Office on Apr. 9, 2025, and Korean Patent Application No. 10-2025-0092972 filed with the Korean Intellectual Property Office on Jul. 10, 2025, the entire contents of which are incorporated herein by reference.

### TECHNICAL FIELD

The present disclosure relates to an under structure of a vehicle body.

### BACKGROUND

Recently, the automotive industry has introduced a new concept of future mobility vision for realizing human-centered dynamic future cities. One of these future mobility solutions is a purpose built vehicle (PBV).

The PBV may be, for example, an eco-friendly moving vehicle based on an electric vehicle (EV). Such a PBV can provide various customized services to a user during a time of moving from an origin to a destination.

The PBV can be manufactured in various shapes and sizes according to a user's use case. For example, the PBV can be utilized as a hailing or delivery type vehicle.

Here, the hailing type vehicle may be utilized as a vehicle on which the transportation disadvantaged can board. In such a vehicle, a ramp module may be installed as a wheelchair boarding device for the transportation disadvantaged.

The ramp module is configured to allow a wheelchair on which the transportation disadvantaged person is boarded to get on and off, and to fix or restrain the wheelchair.

Such a ramp module may be applied to, for example, a floor structure modified by a specialized work such as cutting an underfloor of a general vehicle. In addition, the ramp module may be applied to an aluminum body type floor structure manufactured by an original equipment manufacturing method from an initial design stage of a vehicle body as another example.

However, in the former case, because the floor structure of a base vehicle body is modified, additional man-hours are required and deformation of the floor structure may occur. In addition, in the latter case, because the floor structure is manufactured as an expensive aluminum body type, manufacturing costs may increase and the customer base may be limited.

The matters described in this background section are prepared to enhance understanding of the background of the present disclosure and may include matters that are not prior art already publicly known, available, or in use.

### SUMMARY

The present disclosure relates to a vehicle body, and more particularly, to an under structure of a vehicle body capable of boarding for the transportation disadvantaged.

Some embodiments of the present disclosure may provide an under structure of a vehicle body that allows a base vehicle body of various vehicle types to be shared as much as possible while being able to be changed to a vehicle capable of boarding for the transportation disadvantaged.

An under structure of a vehicle body according to an embodiment of the present disclosure may include: a front transverse member connected to an upper front portion of a rear floor structure along a vehicle width direction; a rear transverse member disposed to be spaced apart from the front transverse member and connected to an upper portion of the rear floor structure along the vehicle width direction; and a rear flattening panel connected to the front transverse member and the rear transverse member.

The rear floor structure may be a rear floor structure of a base vehicle body.

The rear flattening panel may be connected to a center flattening panel covering a ramp module embedded in a center floor structure.

The under structure of a vehicle body according to an embodiment of the present disclosure may further include an extension transverse member respectively connected to both sides of the rear floor structure along the vehicle width direction and connected to both ends of the front transverse member.

A flattening panel mounting part may be provided on each of the front transverse member, the rear transverse member, and the extension transverse member.

The rear transverse member may be connected to a shock absorber bracket connected to one side of the rear floor structure along the vehicle width direction.

The rear transverse member may be provided with a length smaller than that of the front transverse member, and may be disposed to be spaced apart from the other side of the rear floor structure along the vehicle width direction.

The under structure of a vehicle body according to an embodiment of the present disclosure may further include a front cross member disposed along the vehicle width direction at a lower front portion of the rear floor structure at a position corresponding to the front transverse member, a middle cross member disposed along the vehicle width direction at a lower portion of the rear floor structure at a position corresponding to the rear transverse member, and a rear cross member disposed along the vehicle width direction at a lower rear portion of the rear floor structure.

Each of the front transverse member and the front cross member may form a closed cross-section connected to an upper portion and a lower portion of a rear floor panel of the rear floor structure.

Each of the rear transverse member and the middle cross member may form a closed cross-section connected to the upper portion and the lower portion of the rear floor panel.

The under structure of a vehicle body according to an embodiment of the present disclosure may further include a first longitudinal member connected to one side of the front transverse member and the upper portion of the rear floor structure and connected to the rear transverse member along a vehicle longitudinal direction, and a second longitudinal member connected to the other side of the front transverse member and the upper portion of the rear floor structure along the vehicle longitudinal direction.

The rear transverse member may be provided with a length smaller than that of the front transverse member, one end of the rear transverse member may be connected to one side of the rear floor structure along the vehicle width direction, and the other end of the rear transverse member may be spaced apart from the other side of the rear floor structure along the vehicle width direction.

The second longitudinal member may be disposed along the vehicle longitudinal direction between the other end of the rear transverse member and the other side of the rear floor structure.

The under structure of a vehicle body according to an embodiment of the present disclosure may further include an extension longitudinal member connected to the second longitudinal member along the vehicle longitudinal direction and connected to the upper portion of the rear floor structure.

A front cross member may be disposed along the vehicle width direction at a lower front portion of the rear floor structure at a position corresponding to the front transverse member, a middle cross member may be disposed along the vehicle width direction at a lower portion of the rear floor structure at a position corresponding to the rear transverse member, and a rear cross member may be disposed along the vehicle width direction at a lower rear portion of the rear floor structure.

A first seat mounting part may be provided at a set position of the rear floor structure corresponding to the rear cross member, and an extension longitudinal member connected to the second longitudinal member along the vehicle longitudinal direction may be connected to the first seat mounting part, and a second seat mounting part may be provided at a set position of the rear floor structure corresponding to the middle cross member, and the second longitudinal member and the extension longitudinal member may be connected to the second seat mounting part.

At least one anchor mounting part may be provided on each of the first longitudinal member and the second longitudinal member.

Using an under structure of a vehicle body according to some embodiments of the present disclosure, extensibility of a body according to a purpose of use and a use case of a PBV can be secured, combined production according to specifications of a vehicle body is possible, and it is possible to respond to a multi-specification PBV market.

Advantages that can be obtained or predicted due to some example embodiments will be directly or implicitly disclosed in the detailed description of the disclosed example embodiments. That is, various advantages predicted according to some example embodiments will be disclosed in the detailed description to be described later.

### BRIEF DESCRIPTION OF THE DRAWINGS

These drawings are for reference in explaining the disclosed example embodiments, and thus technical ideas of the present disclosure should not be interpreted as being necessarily limited to the accompanying drawings.

FIGS. 1 and 2 are views showing a vehicle body of a PBV applied to an under structure of a vehicle body according to an example embodiment of the present disclosure.

FIG. 3 is a view showing a wheelchair boarding state of a PBV applied to an under structure of a vehicle body according to an example embodiment of the present disclosure.

FIG. 4 is a plan view showing an under structure of a vehicle body according to an example embodiment of the present disclosure.

FIGS. 5 and 6 are perspective views showing an under structure of a vehicle body according to an example embodiment of the present disclosure.

FIG. 7 is a view showing a flattening panel mounting part applied to an under structure of a vehicle body according to an example embodiment of the present disclosure.

FIG. 8 is a bottom perspective view showing an under structure of a vehicle body according to an example embodiment of the present disclosure.

FIG. 9 is a cross-sectional view showing an under structure of a vehicle body according to an example embodiment of the present disclosure.

FIG. 10 is a view showing a seat mounting part applied to an under structure of a vehicle body according to an example embodiment of the present disclosure.

FIG. 11 is a view showing an anchor mounting part applied to an under structure of a vehicle body according to an example embodiment of the present disclosure.

The drawings referred to above are not necessarily shown to scale, and it may be understood that they may present a somewhat simplified representation of various features illustrating some principles of the disclosed example embodiments. For example, specific design features of the disclosed example embodiments including specific dimensions, orientations, locations, and shapes may be determined in part by the specific intended application and use environment.

### DETAILED DESCRIPTION OF ILLUSTRATIVE EMBODIMENTS

Next, some example embodiments will be described in detail with reference to the accompanying drawings so that those of ordinary skill in the art to which the present disclosure belongs can easily carry out embodiments of the present disclosure. However, the disclosed example embodiments may be implemented in many different forms and the present disclosure is not necessarily limited to the example embodiments described herein.

Terminology used herein is for the purpose of describing particular example embodiments and is not intended to be necessarily limiting of the present disclosure. As used herein, singular forms may include plural forms as well, unless the context clearly indicates otherwise.

It may be further understood that the terms “including” and/or “comprising” when used in this specification specify the presence of stated features, integers, steps, operations, elements, and/or components, but do not preclude the presence or addition of one or more other features, integers, steps, operations, components, and/or groups thereof. As used herein, the term “and/or” includes any one or all combinations of one or more of the associated listed items.

In this specification, the term “connected” may indicate a physical relationship between two components in which the components are directly connected to each other by welding, SPR Self Piercing Rivet, FDS Flow Drill Screw, structural adhesive, or the like, or indirectly connected through one or more intermediate components, for example.

“Vehicle”, “of a vehicle”, “automobile” as used herein or other similar terms used in this specification may include passenger automobiles including passenger vehicles, sports cars, sports utility vehicles SUV, buses, tractors, trucks, various commercial vehicles, and may include hybrid vehicles, electric vehicles, hybrid electric vehicles, electric vehicle based purpose built vehicle PBV, hydrogen-powered vehicles, and other alternative fuel vehicles e.g., fuel derived from resources other than petroleum, for example.

Next, some example embodiments of the present disclosure will be described in detail with reference to the accompanying drawings.

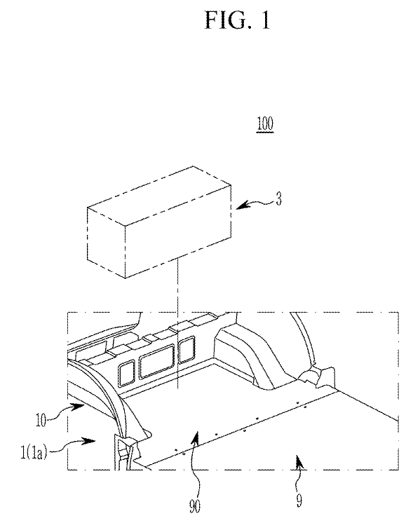

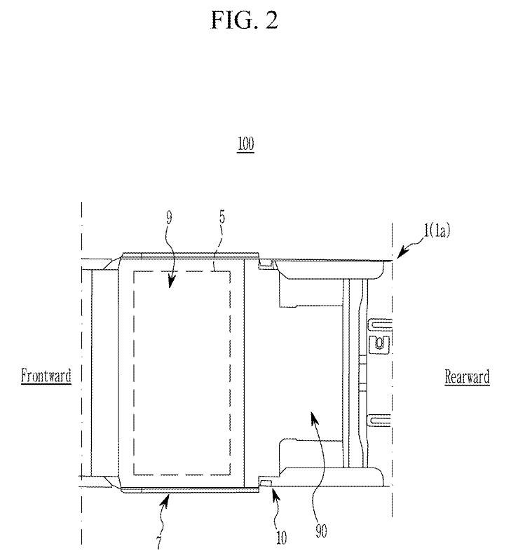

FIGS. 1 and 2 are views showing a vehicle body of a PBV applied to an under structure of a vehicle body according to an example embodiment.

Referring to FIGS. 1 and 2 , an under structure of a vehicle body 100 according to some embodiments may be applied to, for example, a vehicle body 1 of a purpose built vehicle (hereinafter referred to as “PBV”).

In some embodiments, the PBV may be utilized as, for example, an electric vehicle based life module vehicle that provides various customized services to a user during a time of moving from an origin to a destination.

In some embodiments, the vehicle body 1 of such a PBV can be manufactured in various shapes and sizes according to a purpose of use and a use case of the PBV.

In some embodiments, the vehicle body 1 of the PBV may be utilized for various vehicle types, for example, a hailing vehicle as a passenger transport means, a delivery vehicle for goods transport, and a special vehicle such as an ambulance.

In this specification, a reference direction for describing the following components may be set based on the vehicle body as a vehicle longitudinal direction (e.g., a vehicle body length direction or longitudinal direction), a vehicle width direction (e.g., a transverse direction or left-right direction), and an up-down direction (e.g., a height direction).

In this specification, “upper end part”, “upper portion”, “upper end” or “upper surface” of a component may indicate an end, part, portion, or surface of the component that is relatively on the upper side in the drawings, and “lower end part”, “lower portion”, “lower end” or “lower surface” of a component may indicate an end, part, portion, or surface of the component that is relatively on the lower side in the drawings.

In this specification, an end (e.g., one end, the other end, or both ends, etc.) of a component may indicate an extremity of the component in any one direction, and an end part (e.g., one end part, the other end part, both end parts, a front end part, or a rear end part, etc.) of a component may indicate a certain portion of the component including that extremity.

In some embodiments, the PBV may be utilized as a hailing vehicle in which a sliding door is mounted on a side part along the vehicle width direction of the vehicle body 1.

In some embodiments, the PBV may include a rear seat assembly 3 mounted on a rear part of the vehicle body 1.

In some embodiments, the rear seat assembly 3 may be provided in, for example, a cushion tip up and down method having a seat cushion rotatable in the up-down direction. The configuration and operation of the rear seat assembly 3 of such a cushion tip up and down method may be apparent to those of ordinary skill in the art, so a detailed description thereof will be omitted.

In some embodiments, the PBV may include a ramp module 5, which may be a wheelchair boarding device for boarding of the transportation disadvantaged.

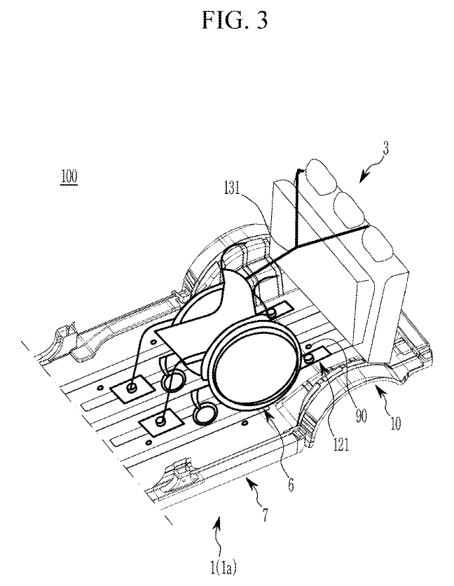

FIG. 3 is a view showing a wheelchair boarding state of a PBV applied to an under structure of a vehicle body according to an example embodiment.

In some embodiments, the ramp module 5 may be a wheelchair boarding and alighting auxiliary step device, and as illustrated in FIG. 3, may be configured to allow a wheelchair 6 on which the transportation disadvantaged person is boarded to get on and off through an opening part of the sliding door.

In some embodiments, the ramp module 5 may be mounted in, for example, a center floor structure 7 of the vehicle body 1 in an in-floor method. The ramp module 5 may protrude to the outside of the vehicle body 1 when necessary in a state of being inserted into the center floor structure 7.

In some embodiments, the vehicle body 1 of the PBV may include a rear floor structure 10 connected to a rear part of the center floor structure 7. The rear floor structure 10 may include a combination of panel and member parts.

For some embodiments, in the rear floor structure 10, the rear seat assembly 3 of the cushion tip up and down method may be mounted.

Therefore, in some embodiments, in a state where the rear seat assembly 3 is cushion tipped up, the wheelchair 6 can enter onto the rear floor structure 10 or come out to the outside of the vehicle by the ramp module 5.

In some embodiments, the vehicle body 1 of the PBV may be a base vehicle body 1a of various vehicle types (e.g., a vehicle type of a hailing vehicle). The base vehicle body 1a of various vehicle types may be a common part that is not replaced even if specifications of the PBV are changed according to the purpose of use and use case of the PBV in the some embodiments. The base vehicle body 1a may include the rear floor structure 10 as described above.

In some embodiments, the under structure of a vehicle body 100 can change a base vehicle body 1a of various vehicle types into a vehicle capable of boarding for the transportation disadvantaged while sharing it as much as possible, can flatten a floor to secure a wide indoor space, and provides a structure capable of fixing the wheelchair 6.

In some embodiments, the under structure of a vehicle body 100 can provide a structure capable of strengthening mounting stiffness of the rear seat assembly 3 and rear collision performance of the vehicle body.

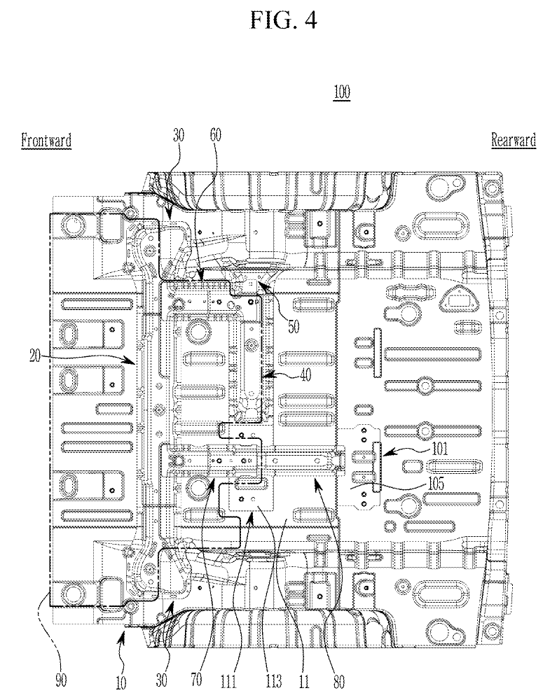

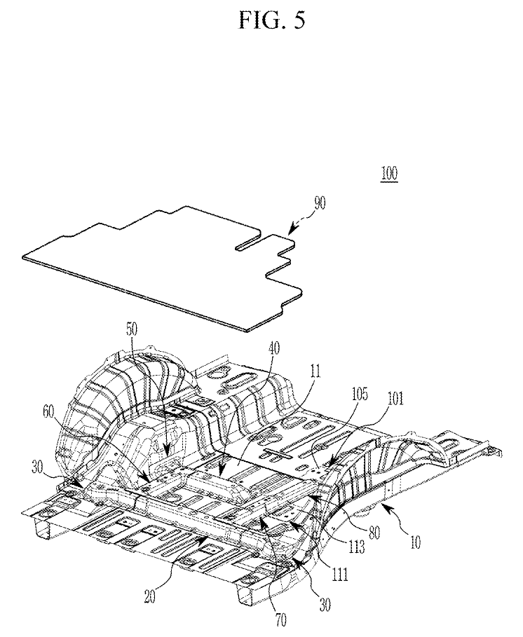

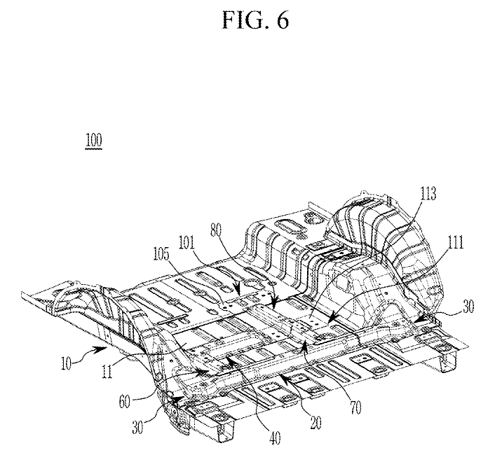

FIG. 4 is a plan view showing an under structure of a vehicle body according to an example embodiment. FIGS. 5 and 6 are perspective views showing an under structure of a vehicle body according to an example embodiment.

Referring to FIGS. 1 to 6 , in some embodiments, the under structure of a vehicle body 100 may include a front transverse member 20, an extension transverse member 30, a rear transverse member 40, a shock absorber bracket 50, a first longitudinal member 60, a second longitudinal member 70, and an extension longitudinal member 80.

In some embodiments, the under structure of a vehicle body 100 may further include a rear flattening panel 90.

In some embodiments, the front transverse member 20, the extension transverse member 30, the rear transverse member 40, the shock absorber bracket 50, the first longitudinal member 60, the second longitudinal member 70, and the extension longitudinal member 80 may be mounted on an upper portion of the rear floor structure 10.

In some embodiments, the rear floor structure 10 may include a rear floor panel 11. The front transverse member 20, the extension transverse member 30, the rear transverse member 40, the shock absorber bracket 50, the first longitudinal member 60, the second longitudinal member 70, and the extension longitudinal member 80 may be mounted on an upper portion of the rear floor panel 11 in a grid form.

In some embodiments, the front transverse member 20 may be connected to an upper front portion of the rear floor structure 10 along the vehicle width direction.

In some embodiments, the front transverse member 20 may be provided in a shape formed upwardly at both side edge ends along the vehicle longitudinal direction. The front transverse member 20 may be provided as a member made of a steel material, for example.

Such a front transverse member 20 may be connected to the upper front portion of the rear floor panel 11 by welding, for example.

In some embodiments, the extension transverse member 30 may be configured to reinforce stiffness along the vehicle width direction of the front transverse member 20. The extension transverse member 30 may be connected to both side parts of the rear floor structure 10 along the vehicle width direction, and may be connected to both ends of the front transverse member 20.

In some embodiments, each of the extension transverse members 30 may be provided in a shape formed upwardly at an edge portion. Each of the extension transverse members 30 may be provided as a member made of a steel material, for example.

In some embodiments, each of the extension transverse members 30 may be connected to both side parts of the rear floor structure 10 along the vehicle width direction by welding, and may be connected to both ends of the front transverse member 20 by welding.

In some embodiments, the rear transverse member 40 may be disposed to be spaced apart to the rear of the front transverse member 20. The rear transverse member 40 may be connected to the upper portion of the rear floor structure 10 along the vehicle width direction.

In some embodiments, the rear transverse member 40 may be provided in a shape formed upwardly at both side edge ends along the vehicle longitudinal direction. The rear transverse member 40 may be provided as a member made of a steel material, for example.

In some embodiments, such a rear transverse member 40 may be connected to the upper portion of the rear floor panel 11 by welding.

In some embodiments, the rear transverse member 40 may be provided with a length smaller than that of the front transverse member 20. One end of the rear transverse member 40 along the vehicle width direction may be connected to one side of the rear floor structure 10 along the vehicle width direction. And, the rear transverse member 40 may be disposed to be spaced apart from the other side of the rear floor structure 10 along the vehicle width direction. That is, in some embodiments, the other end of the rear transverse member 40 along the vehicle width direction may be spaced apart from the other side of the rear floor structure 10.

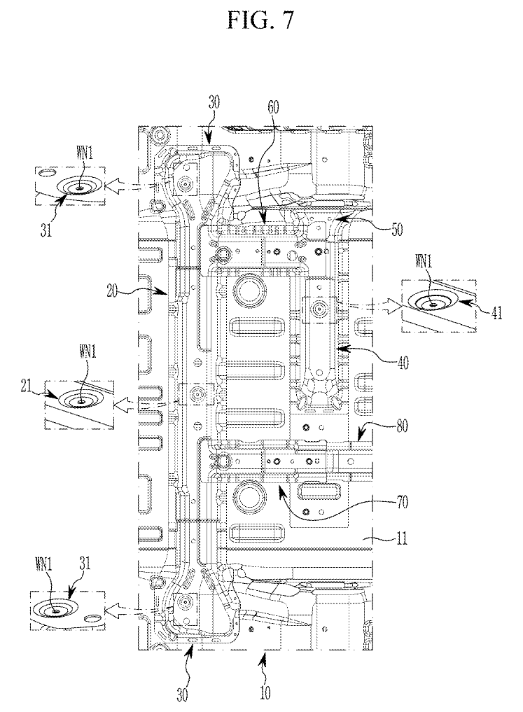

FIG. 7 is a view showing a flattening panel mounting part applied to an under structure of a vehicle body according to an example embodiment.

For some embodiments, in each of the front transverse member 20, the extension transverse member 30, and the rear transverse member 40, a flattening panel mounting part 21, 31, 41 may be provided, respectively, as illustrated in FIG. 7.

In some embodiments, the flattening panel mounting part 21, 31, 41 is configured to mount the rear flattening panel 90, which will be described later, to the front transverse member 20, the extension transverse member 30, and the rear transverse member 40.

In some embodiments, the shock absorber bracket 50 may be configured to mount a shock absorber and reinforce stiffness along the vehicle width direction of the rear transverse member 40.

In some embodiments, the shock absorber bracket 50 may be connected to one side of the rear floor structure 10 along the vehicle width direction. The shock absorber bracket 50 may be connected to one end of the rear transverse member 40 along the vehicle width direction.

In some embodiments, the shock absorber bracket 50 may be provided in a shape formed in the vehicle width direction at an edge portion. The shock absorber bracket 50 may be provided as a bracket made of a steel material, for example.

In some embodiments, the shock absorber bracket 50 may be connected to one side of the rear floor structure 10 by welding, and may be connected to one end of the rear transverse member 40 by welding.

In some embodiments, the first longitudinal member 60 may be configured to reinforce rear collision stiffness of the vehicle.

In some embodiments, the first longitudinal member 60 may be connected to one side of the front transverse member 20 and the upper portion of the rear floor structure 10. The first longitudinal member 60 may be connected to the rear transverse member 40 along the vehicle longitudinal direction.

In some embodiments, the first longitudinal member 60 may be provided in a shape formed upwardly at both side edge ends along the vehicle width direction. The first longitudinal member 60 may be provided as a member made of a steel material, for example.

In some embodiments, a front end of the first longitudinal member 60 along the vehicle longitudinal direction may be connected by welding to a coupling portion of the front transverse member 20 and the extension transverse member 30 at one side of the rear floor structure 10 along the vehicle width direction.

In some embodiments, a rear end of the first longitudinal member 60 along the vehicle longitudinal direction may be connected by welding to a coupling portion of the rear transverse member 40 and the shock absorber bracket 50 at one side of the rear floor structure 10 along the vehicle width direction.

In some embodiments, the first longitudinal member 60 may be connected by welding to the upper portion of the rear floor panel 11 between the front transverse member 20 and the rear transverse member 40.

In some embodiments, the second longitudinal member 70 may be configured to reinforce rear collision stiffness of the vehicle together with the first longitudinal member 60.

In some embodiments, the second longitudinal member 70 may be connected to the other side of the front transverse member 20 and the upper portion of the rear floor structure 10 along the vehicle longitudinal direction.

In some embodiments, the second longitudinal member 70 may be provided in a shape formed upwardly at both side edge ends along the vehicle width direction. The second longitudinal member 70 may be provided as a member made of a steel material, for example.

In some embodiments, a front end of the second longitudinal member 70 may be connected by welding to the front transverse member 20 at the other side of the rear floor structure 10 along the vehicle width direction. The second longitudinal member 70 may be connected to the upper portion of the rear floor panel 11 by welding.

In some embodiments, the extension longitudinal member 80 may be configured to reinforce stiffness along the vehicle longitudinal direction of the second longitudinal member 70.

In some embodiments, the extension longitudinal member 80 may be connected to the second longitudinal member 70 along the vehicle longitudinal direction, and may be connected to the upper portion of the rear floor structure 10.

In some embodiments, the extension longitudinal member 80 may be provided in a shape formed upwardly at both side edge ends along the vehicle width direction. The extension longitudinal member 80 may be provided as a member made of a steel material, for example.

In some embodiments, a front end of the extension longitudinal member 80 may be connected by welding to a rear end of the second longitudinal member 70 at the other side of the rear floor structure 10 along the vehicle width direction. The extension longitudinal member 80 may be connected to the upper portion of the rear floor panel 11 by welding.

In some embodiments, the second longitudinal member 70 and the extension longitudinal member 80 may be disposed along the vehicle longitudinal direction between the other end of the rear transverse member 40 and the other side of the rear floor structure 10.

In some embodiments, the rear flattening panel 90 may be configured to secure a wide indoor space of the vehicle, secure mobility of the wheelchair 6 entering the interior of the vehicle, and secure support stiffness of the wheelchair 6.

In some embodiments, the rear flattening panel 90 may be connected to the front transverse member 20, the extension transverse member 30, and the rear transverse member 40 so as to form a flattened floor surface on the upper side of the rear floor structure 10.

In some embodiments, the rear flattening panel 90 may be provided as a plate material made of a steel material. The rear flattening panel 90 may be mounted on the flattening panel mounting part 21, 31, 41 provided on each of the front transverse member 20, the extension transverse member 30, and the rear transverse member 40.

In some embodiments, the rear flattening panel 90 may be fastened to the flattening panel mounting part 21, 31, 41 as illustrated in FIG. 7 by a fastening member including bolts, nuts, etc.

In some embodiments, the flattening panel mounting part 21, 31, 41 may include a weld nut WN1 connected to each of the front transverse member 20, the extension transverse member 30, and the rear transverse member 40.

In some embodiments, the rear flattening panel 90 may be connected on the same plane along the vehicle longitudinal direction with a center flattening panel 9 covering a ramp module 5 embedded or inserted in the center floor structure 7.

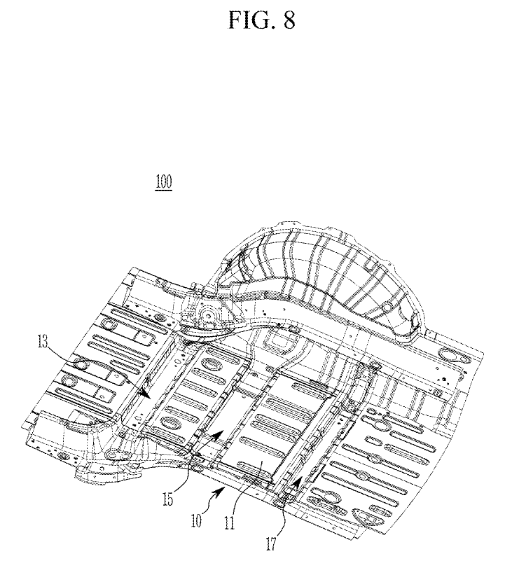

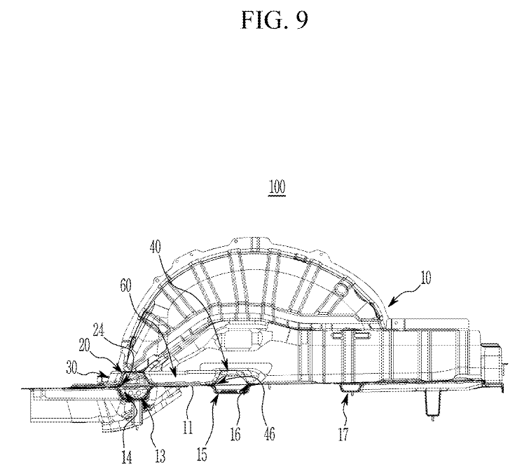

FIG. 8 is a bottom perspective view showing an under structure of a vehicle body according to an example embodiment. FIG. 9 is a cross-sectional view showing an under structure of a vehicle body according to an example embodiment.

Referring to FIGS. 4 to 9 , in some embodiments, the under structure of a vehicle body 100 may further include a front cross member 13, a middle cross member 15, and a rear cross member 17 provided in the rear floor structure 10.

In some embodiments, the front cross member 13, the middle cross member 15, and the rear cross member 17 may be configured to reinforce panel stiffness of the rear floor panel 11.

In some embodiments, the front cross member 13 may be disposed along the vehicle width direction at a lower front portion of the rear floor structure 10 at a position corresponding to the front transverse member 20.

In some embodiments, the front cross member 13 may be provided in a shape formed downwardly at both side edge ends along the vehicle longitudinal direction. The front cross member 13 may be provided as a member made of a steel material, for example.

In some embodiments, the front cross member 13 may be connected by welding to a lower surface of the rear floor panel 11 along the vehicle width direction.

In some embodiments, the front transverse member 20 may be connected to the upper front portion of the rear floor panel 11, and the front cross member 13 may be connected to the lower front portion of the rear floor panel 11.

Accordingly, in some embodiments, each of the front transverse member 20 and the front cross member 13 may form a closed cross-section 24, 14, as illustrated in FIG. 9, connected to the upper portion and the lower portion of the rear floor panel 11.

In some embodiments, the middle cross member 15 may be disposed along the vehicle width direction at a lower portion of the rear floor structure 10 at a position corresponding to the rear transverse member 40.

In some embodiments, the middle cross member 15 may be provided in a shape formed downwardly at both side edge ends along the vehicle longitudinal direction. The middle cross member 15 may be provided as a member made of a steel material, for example.

In some embodiments, the middle cross member 15 may be connected by welding to the lower surface of the rear floor panel 11 along the vehicle width direction.

In some embodiments, the rear transverse member 40 may be connected to the upper portion of the rear floor panel 11, and the middle cross member 15 may be connected to the lower portion of the rear floor panel 11.

Accordingly, in some embodiments, each of the rear transverse member 40 and the middle cross member 15 may form a closed cross-section 46, 16, as illustrated in FIG. 9, connected to the upper portion and the lower portion of the rear floor panel 11.

In some embodiments, the rear cross member 17 may be disposed along the vehicle width direction at a lower rear portion of the rear floor structure 10.

In some embodiments, the rear cross member 17 may be provided in a shape formed downwardly at both side edge ends along the vehicle longitudinal direction. The rear cross member 17 may be provided as a member made of a steel material, for example.

In some embodiments, the rear cross member 17 may be connected by welding to the lower surface of the rear floor panel 11 along the vehicle width direction.

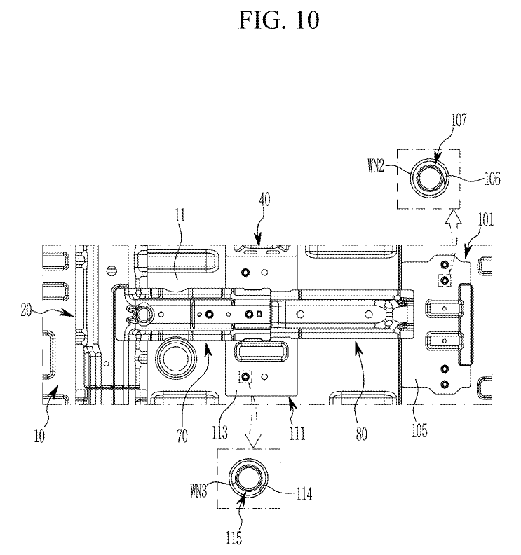

FIG. 10 is a view showing a seat mounting part applied to an under structure of a vehicle body according to an example embodiment.

Referring to FIG. 10, in some embodiments, the under structure of a vehicle body 100 may further include a first seat mounting part 101 and a second seat mounting part 111 provided in the rear floor structure 10.

In some embodiments, the first seat mounting part 101 and the second seat mounting part 111 may be configured to mount the rear seat assembly 3, as illustrated in FIGS. 1 and 3 , on the upper portion of the rear floor structure 10.

As illustrated in FIG. 4, in some embodiments, the first seat mounting part 101 and the second seat mounting part 111 may be exposed to the outside without being covered by the rear flattening panel 90.

In some embodiments, the first seat mounting part 101 may be disposed in the rear floor structure 10 at a position corresponding to the rear cross member 17, as illustrated in FIGS. 5,8 and 9 .

In some embodiments, the first seat mounting part 101 may include a first seat mounting plate 105 and first seat mounting fastening parts 107, as illustrated in FIG. 10.

The first seat mounting plate 105 may be provided as a plate made of a steel material, for example. The first seat mounting plate 105 may be connected by welding to the upper portion of the rear floor panel 11 at a set position of the rear floor structure 10, for example, at a position corresponding to the other side of the rear floor structure 10.

In some embodiments, the first seat mounting plate 105 may be connected to a rear end of the extension longitudinal member 80 by welding.

In some embodiments, the first seat mounting fastening parts 107 may be provided in the rear floor panel 11 at positions corresponding to the first seat mounting plate 105. The first seat mounting fastening parts 107 may include weld nuts WN2 connected to the rear floor panel 11.

In some embodiments, the weld nuts WN2 may be connected with a first fastening hole 106 formed in the first seat mounting plate 105.

In some embodiments, the second seat mounting part 111 may be disposed in the rear floor structure 10 at a position corresponding to the middle cross member 15, as illustrated in FIGS. 5.6 and 9, .

In some embodiments, the second seat mounting part 111 may include a second seat mounting plate 113 and second seat mounting fastening parts 115.

The second seat mounting plate 113 may be provided as a plate made of a steel material, for example. The second seat mounting plate 113 may be connected by welding to the upper portion of the rear floor panel 11 at a set position of the rear floor structure 10, for example, between the other end of the rear transverse member 40 and the other side of the rear floor structure 10.

In some embodiments, the second seat mounting plate 113 may be connected to the other end of the rear transverse member 40 by welding. A connection portion of the second longitudinal member 70 and the extension longitudinal member 80 may be connected to an upper portion of the second seat mounting plate 113 by welding, for example.

In some embodiments, the second seat mounting fastening parts 115 may be provided in the rear floor panel 11 at positions corresponding to the second seat mounting plate 113. The second seat mounting fastening parts 115 may include weld nuts WN3 connected to the rear floor panel 11, as illustrated in FIG. 10 for example.

In some embodiments, the weld nuts WN3 may be connected with a second fastening hole 114 formed in the second seat mounting plate 113.

Accordingly, in some embodiments, the rear seat assembly 3, as illustrated in FIGS. 1 and 3 , can be fastened to the first seat mounting fastening parts 107 and the second seat mounting fastening parts 115 by a fastening member including bolts, nuts, etc.

In some embodiments, a bolt may be fastened to the weld nuts WN2, WN3 through the first fastening hole 106 of the first seat mounting plate 105 and the second fastening hole 114 of the second seat mounting plate 113.

Referring to FIG. 3, in some embodiments, the under structure of a vehicle body 100 may include at least one anchor 121 mounted on the rear flattening panel 90.

In some embodiments, the at least one anchor 121 may be configured to fix or restrain the wheelchair 6 on which the transportation disadvantaged person may be boarded to the rear flattening panel 90.

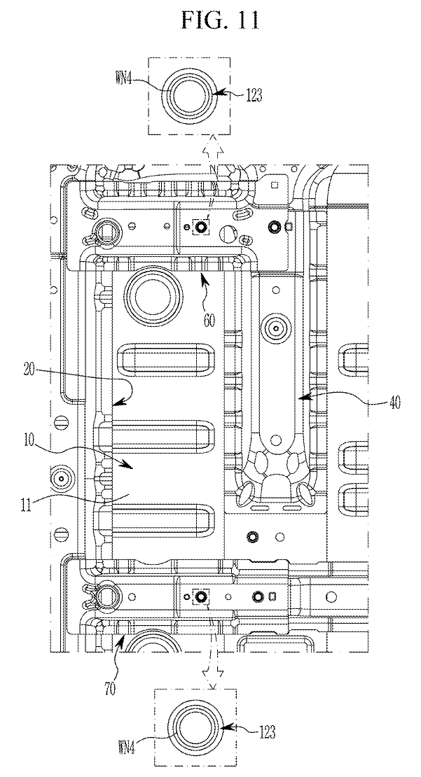

FIG. 11 is a view showing an anchor mounting part applied to an under structure of a vehicle body according to an example embodiment.

Referring to FIGS. 3 and 11 , in some embodiments, at least one anchor mounting part 123 may be respectively provided on the first longitudinal member 60 and the second longitudinal member 70.

In some embodiments, the at least one anchor mounting part 123 may be configured to mount the at least one anchor 121 to the rear flattening panel 90.

In some embodiments, the at least one anchor 121 may be fastened to the at least one anchor mounting part 123 by a fastening member including bolts, nuts, etc.

In some embodiments, the at least one anchor mounting part 123 may include a weld nut WN4 respectively connected to the first longitudinal member 60 and the second longitudinal member 70, as illustrated in FIG. 11.

As illustrated in FIG. 3, some embodiment may include a detachable belt 131. The detachable belt 131 may be installed in the rear seat assembly 3. In some embodiments, the detachable belt 131 fixes the wheelchair 6 and can protect the transportation disadvantaged person boarded on the wheelchair 6.

Next, an assembly process and operation of the under structure of a vehicle body 100 according to some embodiments configured as described above will be described in detail with reference to FIGS. 1 to 11 .

In some embodiments, the base vehicle body 1a of various vehicle types may be provided. The base vehicle body 1a may include the center floor structure 7 and the rear floor structure 10.

In some embodiments, the rear floor structure 10 includes a front cross member 13, a middle cross member 15, and a rear cross member 17 connected to the lower portion of the rear floor panel 11 along the vehicle width direction (see, e.g., FIG. 9).

In some embodiments, at a position corresponding to the rear cross member 17, the first seat mounting fastening parts 107 of the first seat mounting part 101 may be connected to the rear floor panel 11.

In some embodiments, at a position corresponding to the middle cross member 15, the second seat mounting fastening parts 115 of the second seat mounting part 111 may be connected to the rear floor panel 11.

The front transverse member 20, the extension transverse member 30, the rear transverse member 40, the shock absorber bracket 50, the first longitudinal member 60, the second longitudinal member 70, and the extension longitudinal member 80 may be provided.

In some embodiments, the flattening panel mounting part 21, 31, 41 may be connected to each of the front transverse member 20, the extension transverse member 30, and the rear transverse member 40. In some embodiments, at least one anchor mounting part 123 may be connected to each of the first longitudinal member 60 and the second longitudinal member 70.

In some embodiments, the first seat mounting plate 105 of the first seat mounting part 101 and the second seat mounting plate 113 of the second seat mounting part 111 may be provided.

In such a state, at positions corresponding to the first seat mounting fastening parts 107, the first seat mounting plate 105 may be connected by welding to the upper portion of the rear floor panel 11, for example.

Also, at positions corresponding to the second seat mounting fastening parts 115, the second seat mounting plate 113 may be connected by welding to the upper portion of the rear floor panel 11, for example.

The front transverse member 20 may be connected by welding along the vehicle width direction to the upper front portion of the rear floor panel 11 between both side parts along the vehicle width direction of the rear floor structure 10.

The front transverse member 20 may be disposed at a position corresponding to the front cross member 13. Accordingly, in some embodiments, the front transverse member 20 forms the closed cross-section 24 connected with the upper portion of the rear floor panel 11, and the front cross member 13 can form the closed cross-section 14 connected with the lower portion of the rear floor panel 11.

The extension transverse member 30 may be connected by welding to each of both side parts along the vehicle width direction of the rear floor structure 10. Also, each of the extension transverse members 30 may be connected to both ends of the front transverse member 20 by welding, for example.

In some embodiments, the shock absorber bracket 50 may be connected by welding to one side along the vehicle width direction of the rear floor structure 10.

In some embodiments, the rear transverse member 40 may be connected to the shock absorber bracket 50 by welding, and may be connected by welding along the vehicle width direction to the upper portion of the rear floor panel 11.

In some embodiments, one end of the rear transverse member 40 may be connected to the shock absorber bracket 50. The other end of the rear transverse member 40 may be connected to the second seat mounting plate 113 by welding, and may be spaced apart from the other side of the rear floor structure 10.

In some embodiments, the rear transverse member 40 may be disposed at a position corresponding to the middle cross member 15. Accordingly, in some embodiments, the rear transverse member 40 forms the closed cross-section 46 connected with the upper portion of the rear floor panel 11, and the middle cross member 15 can form the closed cross-section 16 connected with the lower portion of the rear floor panel 11.

In some embodiments, the first longitudinal member 60 may be connected by welding along the vehicle longitudinal direction to the upper portion of the rear floor panel 11 at one side along the vehicle width direction of the rear floor structure 10.

In some embodiments, the front end of the first longitudinal member 60 may be connected by welding to a coupling portion or connection portion of the front transverse member 20 and the extension transverse member 30. The rear end of the first longitudinal member 60 may be connected by welding to a coupling portion or connection portion of the rear transverse member 40 and the shock absorber bracket 50.

In some embodiments, the extension longitudinal member 80 may be connected by welding along the vehicle longitudinal direction to the upper portion of the rear floor panel 11 at the other side along the vehicle width direction of the rear floor structure 10.

In some embodiments, the front end of the extension longitudinal member 80 may be connected to the second seat mounting plate 113 by welding. The rear end of the extension longitudinal member 80 may be connected to the first seat mounting plate 105 by welding.

In some embodiments, the second longitudinal member 70 may be connected by welding along the vehicle longitudinal direction to the upper portion of the rear floor panel 11 at the other side along the vehicle width direction of the rear floor structure 10.

In some embodiments, the front end of the second longitudinal member 70 may be connected to the front transverse member 20 by welding. The rear end of the second longitudinal member 70 may be connected by welding to the front end of the extension longitudinal member 80.

In some embodiments, the connection portion or coupling portion of the second longitudinal member 70 and the extension longitudinal member 80 may be connected by welding to the upper portion of the second seat mounting plate 113. The connection portion of the second longitudinal member 70 and the extension longitudinal member 80 may be disposed at a position corresponding to the middle cross member 15.

In some embodiments, the second longitudinal member 70 and the extension longitudinal member 80 connected to each other may be disposed between the other end of the rear transverse member 40 and the other side of the rear floor structure 10.

For some embodiments, the assembly processes as described above may be performed, for example, in a vehicle body assembly line for assembling the vehicle body 1 in a BIW state. In some embodiments, the vehicle body 1 assembled in the vehicle body assembly line may be transferred to a trim assembly line.

In the trim assembly line, for some embodiments, the ramp module 5 may be mounted in an in-floor method in the center floor structure 7 of the base vehicle body 1a. In some embodiments, the center flattening panel 9 covering the ramp module 5 may be mounted in the center floor structure 7.

In some embodiments, the rear flattening panel 90 may be bolting-connected to the flattening panel mounting part 21, 31, 41 of the front transverse member 20, the extension transverse member 30, and the rear transverse member 40.

In some embodiments, the rear flattening panel 90 may be connected on the same plane as the center flattening panel 9 along the vehicle longitudinal direction.

In some embodiments, at least one anchor 121 may be bolting-connected to the at least one anchor mounting part 123 of the first longitudinal member 60 and the second longitudinal member 70.

In some embodiments, the rear seat assembly 3 may be bolting-connected to the first seat mounting fastening parts 107 and the second seat mounting fastening parts 115 through the first seat mounting plate 105 and the second seat mounting plate 113.

According to the under structure of a vehicle body 100 assembled through a series of assembly processes as described so far in accordance with some embodiments of the present disclosure, the wheelchair 6 on which the transportation disadvantaged person is boarded can enter onto the center flattening panel 9 and the rear flattening panel 90 by the ramp module 5.

Therefore, according to the under structure of a vehicle body 100 according to some embodiments, a wide indoor space of the vehicle can be secured by the rear flattening panel 90, and mobility of the wheelchair 6 entering the interior of the vehicle can be secured.

According to the under structure of a vehicle body 100 according to some embodiments, the rear flattening panel 90 can be mounted on the front transverse member 20 and the extension transverse member 30 on the front cross member 13, and the rear transverse member 40 on the middle cross member 15, while being supported by the first longitudinal member 60 and the second longitudinal member 70.

Thereby, according to the under structure of a vehicle body 100 according to some embodiments, mounting stiffness of the rear flattening panel 90 can be secured, and support stiffness of a passenger and the wheelchair 6 can be reinforced.

According to the under structure of a vehicle body 100 according to some embodiments, the wheelchair 6 entering the interior of the vehicle can be fixed or restrained to the rear flattening panel 90 by the at least one anchor 121.

The at least one anchor 121 may be mounted on the first longitudinal member 60 and the second longitudinal member 70 connected with the front transverse member 20 and the rear transverse member 40.

Therefore, according to the under structure of a vehicle body 100 according to some embodiments, mounting stiffness of an anchor for fixing the wheelchair 6 can be reinforced.

According to the under structure of a vehicle body 100 according to some embodiments, the rear seat assembly 3 can be mounted on the first seat mounting part 101 on the rear cross member 17 and the second seat mounting part 111 on the middle cross member 15.

Thereby, according to the under structure of a vehicle body 100 according to some embodiments, mounting stiffness of the rear seat assembly 3 can be reinforced.

Furthermore, according to the under structure of a vehicle body 100 according to some embodiments, the first longitudinal member 60 and the second longitudinal member 70 are connected along the vehicle longitudinal direction to the front transverse member 20 and the rear transverse member 40.

Therefore, according to the under structure of a vehicle body 100 according to some embodiments, rear collision performance of the vehicle can be reinforced, lifting of the rear seat assembly 3 due to a rear collision load can be prevented, and damage to a battery mounted in the center floor structure 7 can be minimized.

Furthermore, according to the under structure of a vehicle body 100 according to some embodiments, because parts made of a steel material for boarding of the transportation disadvantaged are used for the rear floor structure 10 of the base vehicle body 1a, price competitiveness can be secured.

Furthermore, according to the under structure of a vehicle body 100 according to some embodiments, the rear floor structure 10 of various vehicle types can be shared as much as possible without a structural change of the base vehicle body 1a while being able to be changed to a vehicle capable of boarding for the transportation disadvantaged.

Thereby, according to the under structure of a vehicle body 100 according to some embodiments, extensibility of a body according to the purpose of use and use case of the PBV can be secured, combined production according to the specifications of the vehicle body is possible, and it is possible to respond to a multi-specification PBV market.

While the some example embodiments disclosed above have been described, the present disclosure is not necessarily limited thereto, and it is possible to carry out various modifications for other embodiments of the present disclosure within the scopes of the claims and equivalents thereof.

What is claimed is:

1. An under structure of a vehicle body comprising:
a rear floor structure;
a front transverse member connected to an upper front portion of the rear floor structure along a vehicle width direction;
a rear transverse member disposed to be spaced apart from the front transverse member and connected to an upper portion of the rear floor structure along the vehicle width direction; and
a rear flattening panel on and connected to the front transverse member and the rear transverse member.

2. The under structure of claim 1, wherein the rear floor structure is included as a part of a base vehicle body.

3. The under structure of claim 1, further comprising:
a center floor structure;
a ramp module embedded in the center floor structure; and
a center flattening panel covering the ramp module,
wherein the rear flattening panel is adjacent and planarly aligned with the center flattening panel.

4. The under structure of claim 1, further comprising two extension transverse members respectively connected to both sides of the rear floor structure along the vehicle width direction and connected to both ends of the front transverse member.

5. The under structure of claim 4, further comprising flattening panel mounting parts disposed on the front transverse member, the rear transverse member, and the extension transverse members.

6. The under structure of claim 1, further comprising a shock absorber bracket connected to one side of the rear floor structure along the vehicle width direction, wherein the rear transverse member is connected to the shock absorber bracket.

7. The under structure of claim 6, wherein the rear transverse member has a first length smaller than a second length of the front transverse member, and
wherein the rear transverse member is disposed to be spaced apart from another side of the rear floor structure along the vehicle width direction.

8. The under structure of claim 1, further comprising:
a front cross member disposed along the vehicle width direction at a lower front portion of the rear floor structure at a first position under and corresponding to the front transverse member;
a middle cross member disposed along the vehicle width direction at a lower portion of the rear floor structure at a second position under and corresponding to the rear transverse member; and
a rear cross member disposed along the vehicle width direction at a lower rear portion of the rear floor structure.

9. The under structure of claim 8, wherein each of the front transverse member and the front cross member forms a closed cross-section connected to an upper portion and a lower portion of a rear floor panel of the rear floor structure, respectively.

10. The under structure of claim 9, wherein each of the rear transverse member and the middle cross member forms a closed cross-section connected to the upper portion and the lower portion of the rear floor panel, respectively.

11. The under structure of claim 1, further comprising:
a first longitudinal member extending along a vehicle longitudinal direction, wherein the first longitudinal member is connected to one side of the front transverse member and the upper portion of the rear floor structure, and wherein the first longitudinal member is connected to the rear transverse member; and
a second longitudinal member extending along the vehicle longitudinal direction, connected to another side of the front transverse member, and connected to the upper portion of the rear floor structure.

12. The under structure of claim 11, wherein:
the rear transverse member has a first length smaller than a second length of the front transverse member;
one end of the rear transverse member is connected to one side of the rear floor structure along the vehicle width direction; and
another end of the rear transverse member is spaced apart from another side of the rear floor structure along the vehicle width direction.

13. The under structure of claim 12, wherein the second longitudinal member is disposed along the vehicle longitudinal direction between the other end of the rear transverse member and the other side of the rear floor structure.

14. The under structure of claim 11, further comprising an extension longitudinal member connected to the second longitudinal member along the vehicle longitudinal direction and connected to the upper portion of the rear floor structure.

15. The under structure of claim 11, further comprising:
a front cross member is disposed along the vehicle width direction at a lower front portion of the rear floor structure at a first position under and corresponding to the front transverse member;
a middle cross member is disposed along the vehicle width direction at a lower portion of the rear floor structure at a second position under and corresponding to the rear transverse member; and
a rear cross member is disposed along the vehicle width direction at a lower rear portion of the rear floor structure.

16. The under structure of claim 15, further comprising:
a first seat mounting part disposed at a first set position of the rear floor structure corresponding to the rear cross member;
an extension longitudinal member extending along the vehicle longitudinal direction, connected to the second longitudinal member, and connected to the first seat mounting part; and
a second seat mounting part disposed at a second set position of the rear floor structure corresponding to the middle cross member, wherein the second longitudinal member and the extension longitudinal member are connected to the second seat mounting part.

17. The under structure of claim 11, further comprising at least one anchor mounting part disposed on each of the first longitudinal member and the second longitudinal member.

18. A vehicle comprising:
a center floor structure;
a ramp module embedded in the center floor structure;
a center flattening panel covering the ramp module and connected to the center floor structure;
a rear floor structure;
a front transverse member connected to an upper front portion of the rear floor structure along a vehicle width direction;
a rear transverse member disposed to be spaced apart from the front transverse member and connected to an upper rear portion of the rear floor structure along the vehicle width direction; and
a rear flattening panel on and connected to the front transverse member and the rear transverse member, wherein the rear flattening panel is adjacent and planarly aligned with the center flattening panel.

19. A vehicle structured as a purpose built vehicle (PBV) comprising:
a front body module permanently fixed at a front part of the vehicle;
a center structure permanently fixed to the front body module at a center part of the vehicle, wherein the center structure includes a center floor structure;
a rear structure permanently fixed to center structure at a rear part of the vehicle, wherein the rear structure comprises:
a rear floor structure,
a front transverse member connected to an upper front portion of the rear floor structure along a vehicle width direction, and
a rear transverse member disposed to be spaced apart from the front transverse member and connected to an upper rear portion of the rear floor structure along the vehicle width direction;
a rear body module removably and replaceably coupled to the center structure and the rear structure, wherein the rear body module comprises:
a ramp module embedded in the center floor structure,
a center flattening panel covering the ramp module and connected to the center floor structure, and
a rear flattening panel on and connected to the front transverse member and the rear transverse member, wherein the rear flattening panel is adjacent and planarly aligned with the center flattening panel.

20. The vehicle of claim 19, further comprising:
a foldable rear seat removably coupled to the rear structure; and
wheelchair anchors coupled to the rear flattening panel adjacent the foldable rear seat and spaced apart from the foldable rear seat.
